(19) United States
(12) Patent Application Publication
(10) Pub. No.: US 2009/0037775 A1
(43) Pub. Date: Feb. 5, 2009

(54) MESSAGING SYSTEM BASED GROUP JOINT DEBUGGING SYSTEM AND METHOD

(76) Inventors: Chang Yan Chi, Beijing (CN); Wen Peng Xiao, Heng Yang City (CN)

Correspondence Address: LAW OFFICE OF IDO TUCHMAN (YOR), ECM #72212, PO Box 4668, New York, NY, 10163-4668, US

(21) Appl. No.: 12/182,578

(22) Filed: Jul. 30, 2008

(30) Foreign Application Priority Data
Jul. 30, 2007 (CN) 200710137190.1

(51) Int. Cl. G06F 11/36; G06F 15/16

(52) U.S. Cl. 714/38; 709/204; 714/E11.21

(57) ABSTRACT

A messaging system based group joint debugging system is provided, comprising a master computer and a slave computer in mutual communication with the master computer through network. With the group joint debugging system, multiple members of a geographical distributed development team can do jobs on a same debugging session. The master computer includes capabilities for obtaining a debugging request message containing a debugging command via the messaging system, extracting the debugging command and calling a corresponding debugging function of the program debugger according to the debugging command, and sending execution result of the called debugging function, as a debugging response message, to computers participating in a group joint debugging, such that the group joint debugging is carried out to the program to be debugged. The slave computer includes capabilities for receiving the debugging response message and carrying out automatic debugging on the program according to the debugging command.

### CROSS-REFERENCE TO RELATED APPLICATIONS

This application claims priority under 35 U.S.C. §119 to Chinese Patent Application No. 200710137190.1 filed Jul. 30, 2007, the entire text of which is specifically incorporated by reference herein.

### BACKGROUND OF THE INVENTION

The present invention generally relates to a computer program debugging system and method, and more specifically, to a messaging system based group joint debugging system and method.

In a computer application program development process, to enable a developed computer program to realize functions and effects expected by programmers, debugging is needed to be carried out such that program errors and bugs can be detected and reduced. Nowadays, programmers debug a program in an integrated development environment (IDE). The IDEs herein comprises Eclipse and Microsoft Visual Studio.NET and so forth operating generally in a designated operating system. With these IDEs, when a program is about to be debugged, programmers call that program from an IDE and under the IDE's control, use debugging functions provided by the IDE to control the process of the debugged program, check and change memory variables so as to accomplish the debugging.

FIG. 1 is a schematic block diagram illustrating a computer debugging system of the prior art. In FIG. 1, a general debugging system 100 of the prior art comprises an operating system 110, an IDE 120 and a program to be debugged 130 and so forth. Depending on the IDE 120, the operating system 110 could be varied, or vice versa. The operating system, for instance, may be Windows, Linux and like, thus the corresponding the IDE 120 can be Microsoft Visual Studio.NET, Eclipse and like.

In order to configure the general debugging system 120, a computer needs to be booted up at first and the operating system needs to be started. The IDE is then started in the operating system. The program to be debugged 130 can be loaded by a debugging subsystem in the IDE 120.

In the general debugging system 100 of FIG. 1, when debugging a program under the IDE's control, a programmer selects various debugging functions provided by debugging subsystems of the IDE 120, controls the process of the debugged program and checks memory variables to accomplish the debugging.

The general debugging system 100 of FIG. 1 is usually suitable for a single computer and a single programmer to do debugging job. With continuous development of computer technology, however, complexity of program products to be developed is increasing, so it is difficult for a single programmer with a single computer to develop program products with high quality. In order to meet such a demand, many programmers distributed worldwide need to be grouped up as a program development team to carry out joint development for a software project. In such a circumstance, IDEs also evolve on top of the single computer or single programmer based IDEs, and a technology, so called Symmetrical Joint Debugging, has been adopted by the program development team with members having distributed locations geographically.

FIG. 2 is a schematic diagram illustrating a general symmetric joint debugging system of the prior art. In FIG. 2, as an example, a general symmetric joint debugging system 200 of the prior art comprises two individual and completely equivalent general debugging systems 210 and 220. The general debugging systems 210 and 220 can communicate with each other via network 230, and both of the general debugging systems 210 and 220 are equivalent to the general debugging system 100 of FIG. 1. Generally speaking, an operating system 211, an IDE 213, a program to be debugged 215 and etc. comprised in the general debugging system 210 should be consistent with an operating system 221, an IDE 223, a program to be debugged 225 and etc. comprised in the general debugging system 210. Some commercial IDEs can be used herein as the IDE 213 and the IDE 223.

With the general symmetric joint debugging system 200, members of a geographical distributed development team can collaboratively control the process of the debugged programmed being debugged and check and change memory variables to accomplish the debugging.

However, there are some constrains with the conventional symmetric joint debugging system, which make it difficult to be widely accepted by programmers. These constrains, for example, can comprise:

Base on heavy-weight collaboration technologies like screen sharing, which is very slow and network bandwidth exhausting.

Need symmetrical IDE supporting. Each user should launch an IDE like Eclipse and Visual Studio.NET, and configure it for group joint debugging.

Hard to initialize, organized and maintain debug sessions as most of debug features are designed for individual programmer, not for group.

In particular, need design a proprietary messaging mechanism to deliver debug messages back and forth between different sites during the debug session.

It is found by the inventor that general purpose messaging systems, for example Electronic Mail (Email), Java Message Service (JMS), Session Initiation Protocol (SIP), Instant Messaging (IM) and Peer-to-Peer (P2P) networks have been designed and used to deliver messages or data. Of these general purpose messaging systems, some like email and IM have become well developed and been widely used in our daily life. Unfortunately, however, the messaging systems such as the email and the IM are still used as general communication tools but for supporting software development directly.

In light of such a situation, it is necessary to combine the general purpose messaging systems and the IDEs such that the debugging messages can be efficiently delivered among different sites during the debugging session.

### BRIEF SUMMARY OF THE INVENTION

The present invention is proposed to the above issues of the conventional remote debugging system. The present invention provides a method and system for group joint debugging via general purpose messaging systems to enhance debugging session initialization and simplify debugging message delivering process such that the remote group joint debugging can be better supported.

In order to realize the above and other objectives of the present invention, according to an aspect of the present invention, messaging system based group joint debugging system is provided, which comprising: at least one master computer for loading a program debugger and a program to be debugged via a operating system, obtaining debugging request message containing a debugging command via messaging systems, extracting the debugging command and calling a corresponding debugging function of the program debugger according to the debugging command, and sending execution result of the called debugging function, as a debugging response message, to remaining computers participating in a group joint debugging, such that the group joint debugging is carried out to the program to be debugged; and at least one slave computer in mutual communication with the master computer through network, for generating the debugging command according to a debugging action of a user, forming a debugging request message containing the debugging command, and sending the debugging request message to the master computer through the messaging systems, and for receiving the debugging response of the master computer through the messaging system, extracting the corresponding debugging command and execution result, and keeping staying consistent with processing progress of the master computer.

According to an embodiment of the present invention, the slave computer may be configured with a program debugger for generating a debugging command according to an action of a user thereby generating a debugging request message.

According to an embodiment of the present invention, the slave computer may be loaded with a program to be debugged and may be synchronized with processing progress of the master computer according to a corresponding debugging command in the debugging response message.

According to an embodiment of the present invention, the slave computer needs not to be loaded with a program to be debugged, but can provide the program debugger a corresponding debugging execution result in the debugging response message as a response message of a user debugging action.

According to an embodiment of the present invention, the slave computer needs not to be configured with a program debugger, but can process a user debugging request at client side of a general message process system, encapsulate it as a corresponding debugging command, and generate a debugging request message.

According to an embodiment of the present invention, the messaging systems may be an electronic mail system, instant messaging system, Java message service, session initiation protocol or peer-to-peer network.

According to an embodiment of the present invention, the master computer can be configured with: a first messaging processing system for receiving the debugging request message and outputting the same after being processed through the messaging system, and delivering debugging response message corresponding to the debugging request message to computers participating in the group joint debugging; and a group IDE for generating a debugging command according to the debugging requesting message output from the first messaging processing system, calling a debugging function in the program debugger corresponding to the debugging command to debug the program to be debugged, collecting debugging result information, and forming a debugging response message as a response message to the debugging request message.

According to an embodiment of the present invention, the first messaging processing system can further comprise a debugging message processor for detecting the debugging request message in the incoming messages, delivering the detected debugging request message to the group IDE through a group debugging protocol, and returning response messages output by the group IDE to the computers participating in the group joint debugging after the group IDE finishes the processing on the debugging request message.

According to an embodiment of the present invention, the first messaging processing system can further comprise a messaging delivering means for delivering the debugging request message received from the messaging system to the debugging message processor, and sending the response information delivered from the debugging message processor and regarding the debugging request message to the computers participating in the group joint debugging through the messaging system.

According to an embodiment of the present invention, the debugging message processor can comprise a debugging request message detector for detecting whether the incoming message is the debugging request message for debugging purpose when receiving the message.

According to an embodiment of the present invention, the debugging message processor is implemented as a plug-in, an extension or an additional component of a general messaging system client, the communication between the debugging message processor and the group IDE is implemented by means of inter-process communication mechanism provided by operating systems and the group debugging protocol.

According to an embodiment of the present invention, the debugging message processor is implemented as a plug-in, an extension or an additional component of an existing IDE, and communicates directly with other computers in network through a general messaging protocol. The debugging message processor communicates with the group IDE by means of the group debugging protocol. According to an embodiment of the present invention, the group IDE is implemented as a plug-in, an extension or an additional component of an existing IDE, and comprises: a program debugger for carrying out debugging action according to debugging commands; a remote debugging commander for buffering incoming debugging request messages in a queue fashion, generating debugging commands being understandable by the program debugger, and packetizing response information of the program debugger and sending the same to the first messaging processing system through the group debugging protocol; and a remote debugging stub for receiving a debugging command from the remote debugging commander, calling debugging functions of the program debugger corresponding to the debugging command, and collecting and combining debugging response message after the debugging functions is executed so as to deliver the same to the remote debugging commander.

According to an embodiment of the present invention, the remote debugging commander comprises: a debugging request message delivering means for receiving debugging request messages and buffering the received debugging request messages in a queue fashion; a debugging command generator for generating debugging commands being understandable by the program debugger according to the buffered debugging request messages, and providing the commands to the program debugger via the remote debugging stub such that the program debugger uses the commands to make corresponding control onto the program to be debugged; a debugging output delivering means for delivering the debugging response message to the debugging response message packetizing means after receiving the debugging response message; and a debugging response message packetizing means for packetizing and encoding the delivered debugging response message after receiving it so as to send the same to the first messaging processing system through the group debugging protocol.

According to an embodiment of the present invention, the debugging request messages are packetized and encoded with the group debugging protocol format, and analyzed and translated to the debugging commands by the debugging command generator.

According to an embodiment of the present invention, the group debugging protocol is stemmed from the remote debugging protocol used in the program debugger.

According to an embodiment of the present invention, the remote debugging stub comprises: a debugging command executor for calling corresponding debugging functions in the program debugger to debug the program to be debugged when the debugging command is arrived; and a debugging output monitor for collecting runtime output information and combining it as the debugging response message to be delivered to the remote debugging commander when the program debugger finishes the called corresponding debugging functions.

According to an embodiment of the present invention, the slave computer is configured with a second messaging processing system for receiving the debugging response message from the master computer through the messaging system and processing the same, such that the slave computer generates corresponding debugging output based on the debugging response message.

According to another aspect of the present invention, a messaging system based group joint debugging method is provided, the method comprises steps of: generating a debugging command according to a debugging action of a user, and packetizing and encoding the generated debugging command to form a debugging request message; sending, by a messaging system, the debugging request message to a master computer, on which a program debugger and a program to be debugged are running; receiving, by the master computer, message through the messaging system, and detecting the debugging request message in the received message; extracting the debugging command in the debugging request message; calling debugging functions from the program debugger according to the debugging command in order to control the program to be debugged; collecting debugging results generated by execution of the debugging command after the debugging command has been executed on the program to be debugged; constructing a debugging response message using the debugging results; sending the debugging response message to computers participating in the group joint debugging through the messaging system; and a slave computer analyzing and processing the debugging response message and displaying it to the user as result for the debugging action of the user.

According the another aspect of the present invention, a computer product is provided, on which a program realizing a messaging system based group joint debugging method is implemented, the group joint debugging method comprises steps of: generating a debugging command according to a debugging action of a user, and packetizing and encoding the generated debugging command to form a debugging request message; sending, by a messaging system, the debugging request message to a master computer, on which a program debugger and a program to be debugged are running; receiving, by the master computer, message through the messaging system, and detecting the debugging request message in the received message; extracting the debugging command in the debugging request message; calling debugging functions from the program debugger according to the debugging command in order to control the program to be debugged; collecting debugging results generated by execution of the debugging command after the debugging command has been executed on the program to be debugged; constructing a debugging response message using the debugging results; sending the debugging response message to computers participating in the group joint debugging through the messaging system; and analyzing and processing the debugging response message and displaying it to the user as result for the debugging action of the user.

With the above group joint debugging technology, the present invention allows multiple group members to work on a same debugging session, and fix complex bugs which may be relevant with multiple modules. In particular, globalized development teams may have strong demand towards group joint debugging, especially during system integrating stage.

### BRIEF DESCRIPTION OF THE SEVERAL VIEWS OF THE DRAWINGS

The above and other objectives, features and advantages of the present invention will be more apparent from the following detailed description in connection with the appended drawings, in which:

FIG. 1 is a schematic block diagram illustrating a computer debugging system of the prior art;

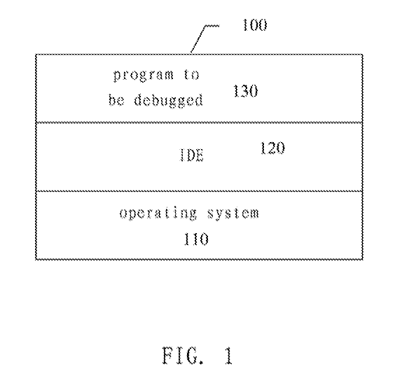

FIG. 2 is a schematic block diagram illustrating a symmetric joint debugging system of the prior art;

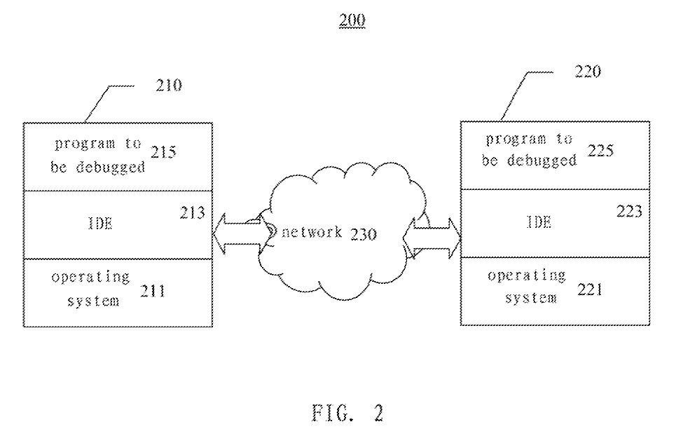

FIG. 3 is a block diagram illustrating a group joint debugging system according to the present invention;

FIG. 4A is a schematic diagram illustrating configuration of a master computer according to the present invention;

FIG. 4B is a schematic diagram illustrating configuration of a slave computer according to an embodiment of the present invention;

FIG. 4C is a schematic diagram illustrating configuration of a slave computer according to another embodiment of the present invention, in which no IDE exits;

FIG. 5A is a flow chart illustrating operation of a program debugger according to the present invention running on a master computer;

FIG. 5B is a flow chart illustrating operation of a program debugger according to the present invention running on a slave computer;

FIG. 6 is a schematic diagram illustrating a remote debugging commander according to the present invention;

FIG. 7 is a schematic diagram illustrating a remote debugging stub according to the present invention;

FIG. 8 is a flow chart illustrating working process of a remote debugging commander according to the present invention;

FIG. 9 is a flow chart illustrating working process of a remote debugging stub according to the present invention;

FIG. 10 is a schematic architecture diagram illustrating a group joint debugging system according to an embodiment of the present invention;

FIG. 11 is a schematic architecture diagram illustrating a group joint debugging system according to another embodiment of the present invention;

FIG. 12 is a schematic architecture diagram illustrating a group joint debugging system according to still another embodiment of the present invention; and

FIG. 13 illustrates operating process of a group joint debugging system according to the present invention.

### DETAILED DESCRIPTION OF THE INVENTION

The present invention will be described in detail hereafter by referring to the drawings illustrating preferable embodiments thereof. It should be understood that the present invention can be implemented by various format but not limited to the embodiments described herein. In fact, the embodiments are provided herein to facilitate delivering the scope of the present invention comprehensively and completely to the person having ordinary skill in the art.

Moreover, like numbers denote like parts, features and contractures throughout the drawings. In addition, the well known functions and configurations incorporated herein will be omitted such that they will not generate inappropriate interference for understanding the present invention correctly.

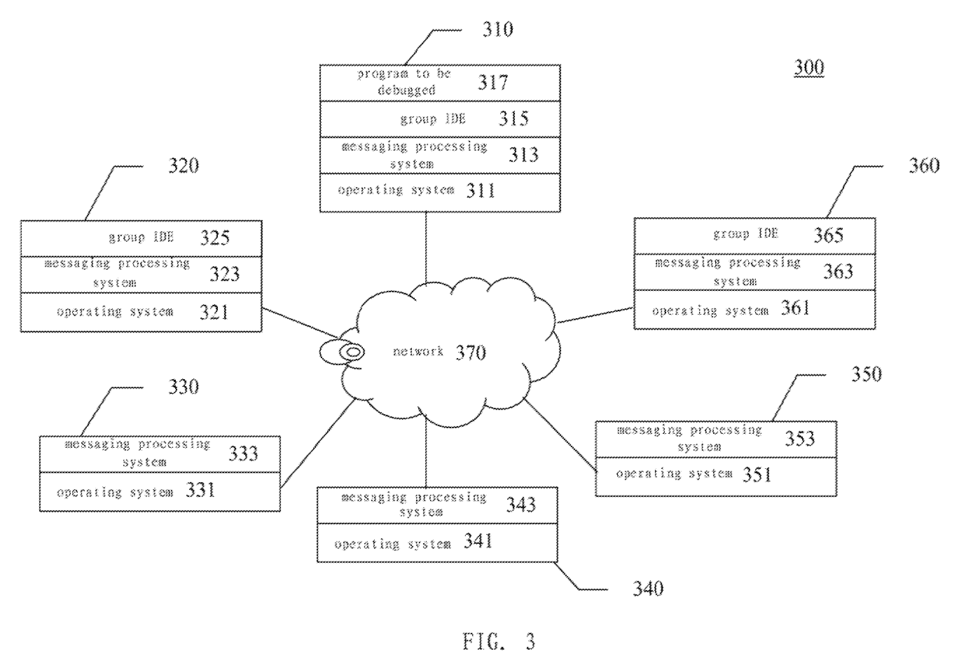

Referring to FIG. 3 at first, FIG. 3 is a block diagram illustrating a group joint debugging system according to the present invention. In FIG. 3, a group joint debugging system 300 comprises a master computer 310 and a plurality of slave computers 320 through 360. These elements communicate with each other via a network 370, wherein the master computer 310 is loaded with a general program debugger and a program to be debugged via an operating system 311 and is capable of receiving the debugging request message from the slave computers via a messaging system on network such as an instant messaging system.

The slave computers 320 through 360 can be configured with or without a program debugger, which is used for receiving a debugging command input by a user or a debugging command generated from the program debugger contained in the slave computer, generating a debugging request message, and sending the generated debugging request message to the master computer 310 through a messaging system such an instant messaging system. Note that in the case that the slave computers 320 through 360 receive a debugging response message from the master computer 310, the debugging command input by a user or the debugging command generated from the program debugger contained in the slave computer may be generated after referring to the debugging response message.

In particular, in the group joint debugging system 300, when a group joint debugging session is undergoing, the operating system 311 is started in the master computer 310, and the messaging processing system 313 is configured for messaging with computers hooked up on the network 370 via the network 370. The master computer 310 also start group IDE 315 based on the messaging processing system 313 thereon, than the program to be debugged 317 is loaded by the group IDE 315. The configuration of the master computer 310 will be described later with more details.

The configurations of the slave computers 320 through 360 contained in the group joint debugging system 330 may be different, but both of them must have an operating system, i.e. the numbers 321, 331, 341, 351 and 361 as shown in FIG. 3. For example, the slave computers 320-360 are configured with messaging systems 323, 333, 343, 353 and 363 for messaging with the master computer 310 and other slave computers through the network 370, and the slave computers 320 and 360 starts group joint IDEs 325 and 365, respectively, based on the messaging systems thereon, but the program to be debugged is not loaded in the group joint IDE, whereas the group joint IDE is not started in other slave computers 330-350.

In particular, in the slave computers 320 and 360 in which the group joint IDE is running, the debugging command can be generated according to the debugging response message received by the slave computers 320 and 360, various debugging runtime information contained in the debugging response message can be applied to the group joint IDE running on the slave computers 320 and 360.

The messaging system 323 and 363 receive and transmit messages from and to networked computers by means of general messaging system via the network 370. The general messaging systems comprise electronic mail system, instant message system, Java message service, session initiation protocol or peer-to-peer network transmission protocol, and can also comprise other network communication protocols such as IP protocol.

The group joint IDEs 325 and 365 generate the debugging request message based on the debugging command received by the slave computers 320 and 360, or receive the debugging response message from the master computer and apply the same to the group joint IDEs 325 and 365.

The slave computer and the master computer can have or not have same architecture as long as the slave computer and the master computer are suitable for running related programs or applications, i.e. there is no special physical architecture requirement for the slave computer and the master computer. Their configuration, however, can be varied, at first the slave computer can be configured with a different group joint IDE, secondly the slave computer can opt to run or not run the program to be debugged even if being configured with the group joint IDE.

Next, the configuration of the master computer 310 will be described in detail. The elements with same names both in the slave computers 320 and 360 and in the master computer have the same functions and configurations, their detailed descriptions, therefore, are omitted.

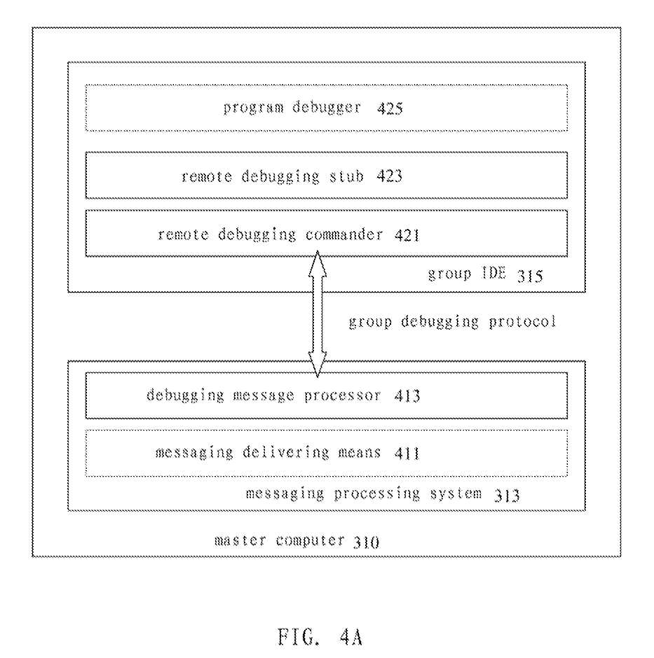

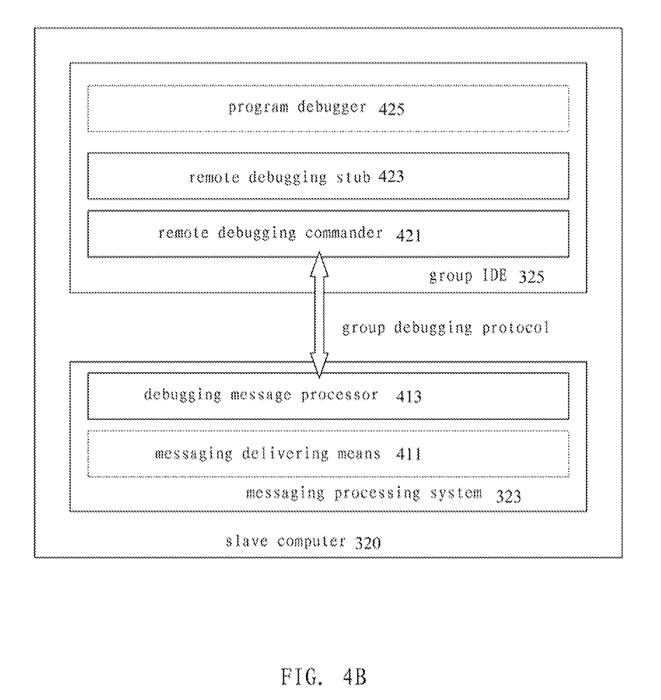

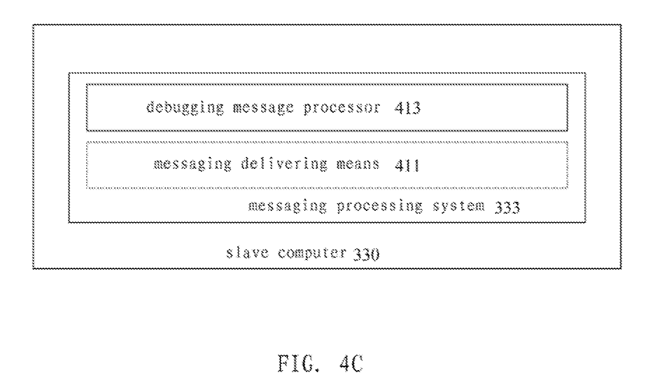

FIG. 4A is a schematic diagram illustrating configuration of the master computer 310 according to the present invention. Referring to 4A, the master computer, during the group joint debugging runtime, mainly comprises two elements, i.e. the messaging processing system 313 and the group joint IDE, in addition to a operating system. The messaging processing system 313 receives and transmits messages from and to networked computers by means of general messaging systems via the network 370. The general messaging systems comprise electronic mail system, instant message system, Java message service, session initiation protocol or peer-to-peer network transmission protocol, and can also comprise other network communication protocols such as IP protocol. The group joint IDE 315 debugs the program to be debugged according to the debugging commands received by the slave computer 310.

The message processing system 313 comprises a messaging delivering means 411 and a debugging message processor 413, both of which can be implemented as a plug-in, an extension or an additional component of an existing messaging processing system client software, and can be used to receive and transmit message from and to the computers participating the group joint debugging, detect the debugging request message from the received message, and send a response message for the debugging request message to the computers participating the group joint debugging. In particular, the messaging processing system 313 receives messages from the computers participating the debugging through network, and detects whether the received message is the debugging request message and sends a response message for the debugging request message to the slave computers participating the debugging. Certainly, the messaging processing system 313 can also communicate with an input/output system of the master computer.

The messaging delivering means 411 receives the debugging request message from the computers participating the group joint debugging and delivers the same to the debugging message processor 413, or sends the debugging response message delivered from the debugging message processor 413 to the computers participating the debugging.

The debugging message processor 413 processes the debugging request message delivered from the messaging delivering means 411 during the group joint debugging process, and delivers the processed debugging request message to the group joint IDE 315 through the group debugging protocol. After the group joint IDE 315 finishes the processing to the corresponding debugging request message, the result of which is processed by the debugging message processor 413 in an proper fashion to form a response message to be delivered to the messaging delivering means 411 which returns the same to the computer requested the corresponding debugging. At this point, the group joint IDE 315 and the messaging processing system 313 are interacted through the group debugging protocol, and physically, by means of some Inter-Process Communications (IPC) mechanisms provided by operating systems, for example, socket and sharing memory in UNIX system.

In particular, the debugging message processor 413 comprises a debugging request message detector, which is called to determine whether a incoming message is a debugging request message for debugging purpose or a general message when the messaging delivering means 411 receives the message through the network 370. If the incoming message is a debugging request message for debugging purpose, then the debugging message processor 413 send it to a remote debugging commander 421 through the group joint debugging protocol. In other hand, when the debugging message processor 413 receives a debugging response message delivered from the remote debugging commander 412 through the group joint debugging protocol, the debugging message processor 413 delivers the received message to the messaging delivering means 411 which processes the same then send it the relevant computers participating the debugging through the network 370.

FIG. 4B is a diagram showing a slave computer configured with the group IDE, and FIG. 4C is a diagram showing a slave computer not configured with the group IDE, wherein like elements are denoted by like numbers. As to the slave computer configured with the group IDE, a debugging request message sending to a master computer is generated by a user debugging action in a program debugger, a debugging response message received by the salve computer will be displayed in the program debugger eventually. As to the slave computer not configured with the group IDE, a debugging request message sending to a master computer is directly input by a user in a messaging system client software, a debugging response message received by the slave computer will also be displayed in the messaging system client software.

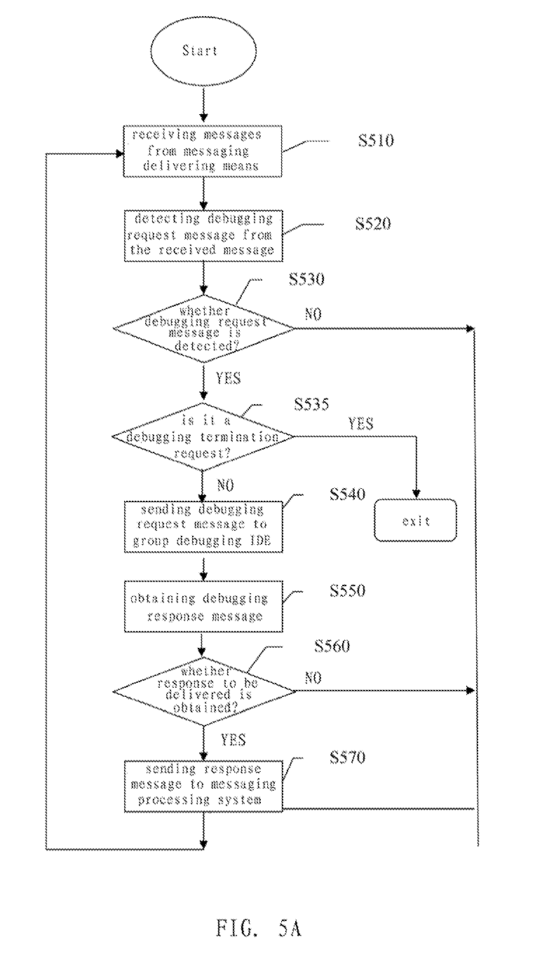

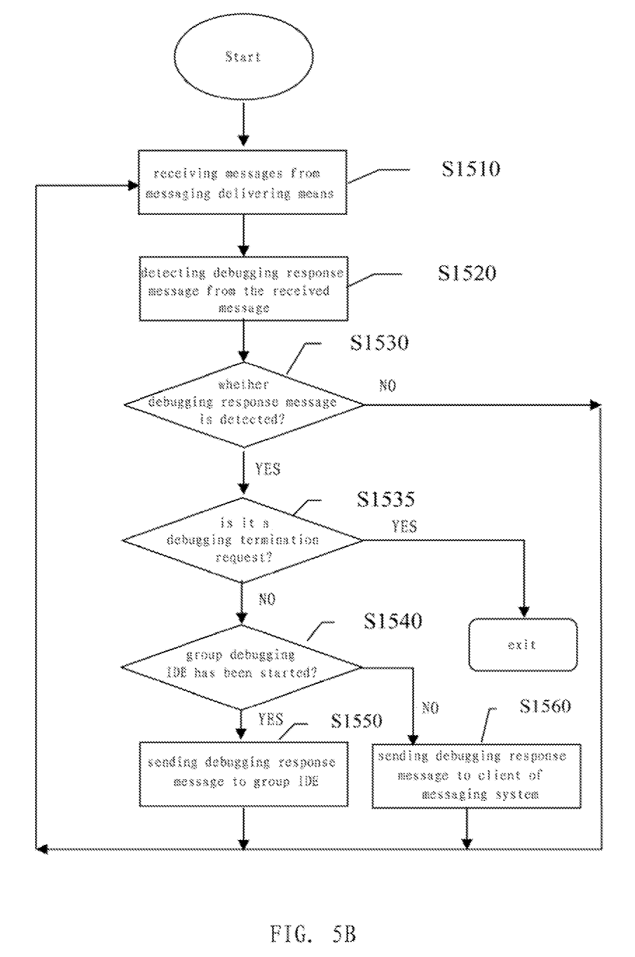

FIG. 5A is a flow chart illustrating operation process of the debugging message processor 413 on a master computer. In step S510, the debugging message processor 413 receives messages from the messaging delivering means 411. Then, when a message is received, the debugging request message detector is called to detect a debugging request message from the received message in step S520.

Next, in step S530, the debugging message processor 413 determines whether a debugging request message is detected from the received message. If no debugging request message is detected, then the process proceeds to S510 for a next session. If the request message detector called in step S520 has detected a debugging request message, then it is determined in step S533 whether the detected debugging request message is a debugging termination request, and if it is determined in step S535 that the detected debugging request message is a debugging termination request message, then the process is terminated.

If it is determined in step S535 that the detected debugging request message is not a debugging termination request message, then in step S540, the detected debugging request message is sent to the group IDE 315 by which debugging is undertaken according to the debugging request.

Next, in step S550, the process waits for a debugging response message sent from the group IDE 315, and in step S560 it is determined whether there is any debugging response message to be delivered, and if there is no debugging response message to be delivered, then process returns to S510 for a next session.

If in step S560 it is determined that there is a debugging response message to be delivered, then in step S570 the debugging response message is sent to the messaging delivering means 411. Then, the process returns to step S510 for a next session.

FIG. 5B is a flow chart illustrating operation of the debugging message processor 413 on a slave computer. In step S1510, the debugging message processor 413 receives messages from the messaging delivering means 411. Then, when a message is received, the debugging response message detector is called to detect a debugging response message from the received message in step S1520.

Next, in step S1530, the debugging message processor 413 determines whether a debugging response message is detected in the received message. If no debugging response message is detected, then the process returns to step S1510 for a next session. If in step S1510 a debugging response message is detected by calling the response message detector, then in step S1535 it is determined whether the detected debugging response message is a debugging termination response, and if in step S1535 it is determined the detected debugging response message is a debugging termination message then the process is terminated.

If in step S1535 it is determined that the detected debugging response message is not a debugging termination response message, then in step S1540 it is determined whether the group IDE 315 is started by the slave computer. If in step S1535 it is determined that the group IDE is started by the slave computer, then the detected debugging response message is sent to group IDE 315 by which the debugging is undertaken according to the debugging response message.

If in step S1535 it is determined that the group IDE is not started by the slave computer, then the detected debugging response message is directly sent to a client of the messaging system which displays the same to users.

Next, the process returns to step S1510 for a next session.

Referring to FIG. 4A again, the group IDE 315 of a master computer comprises a remote debugging commander 421, a remote debugging stub 423 and a program debugger 425. At this point, the program debugger 425 can be a debugging subsystem of an existing IDE or a console based debugger.

The remote debugging commander 421 can be implemented as a plug-in, an extension and an additional component of an existing IDE to process remote debugging request message sent by a slave remote computer through the messaging processing system 313, such that the program debugger 425 can perform debugging action according to a debugging command in a remote debugging request message. In addition, the remote debugging commander 421 also packetizes and encodes output of the program debugger 425 such that it can be sent to corresponding slave computers through the messaging processing system 313.

The remote debugging stub 434 can also be implemented as a plug-in, an extension or an additional component of an existing IDE, and can be used to receive, from the remote debugging commander 421, a debugging command originated from the slave computer, and call debugging functions corresponding to this debugging command, which are provided by the debugging subsystem (i.e. the program debugger 425) of the loaded group IDE.

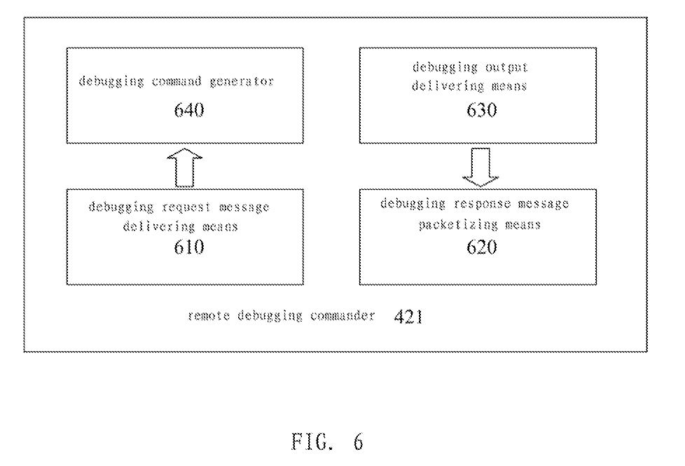

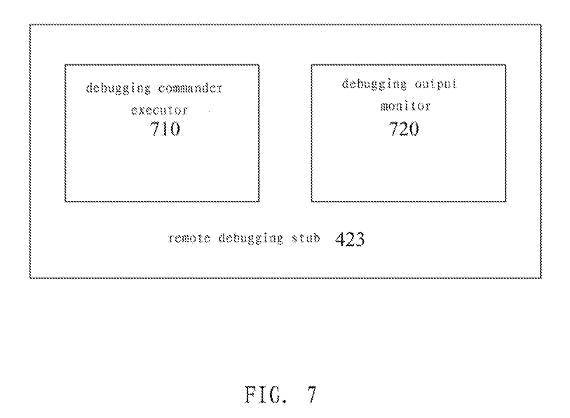

The remote debugging commander 421 and the remote debugging stub 423 will be described in detail hereafter with reference to FIG. 6 and FIG. 7.

FIG. 6 is a schematic diagram illustrating configuration of the remote debugging commander 421. Referring to FIG. 6, the remote debugging commander 421 comprises a debugging request message delivering means 610, a debugging response message packetizing means 620, a debugging output delivering means 630 and a debugging generator 640. At this point, the debugging request message delivering means 610 receives all remote debugging request messages, and buffers the all received remote debugging request message in a queue fashion. These debugging request message are packetized and encoded in the group debugging protocol format, and analyzed and translated to debugging commands by the debugging command generator 640. The group debugging protocol is related to operating systems, programming languages and existing debuggers, and can be derived from an existing remote debugging protocol in an existing debugger. For example, a break point can be set in line 110 of the source file HelloWorld.java by using following packet:

#breakpoint$HelloWorld.java$110

In other hand, the remote debugging commander 421 receives runtime output of the debugger through the debugging output delivering means 630, and packetizes and encodes the runtime output according to the group debugging protocol with help of the debugging response message packetizing means 620.

In particular, when the slave computer sends a debugging request message, the debugging request message delivering means 610 receives, from the messaging processing system 313, and buffers the debugging request message, which is sent by the slave computer and contains debugging commands, and delivers the debugging request message to the debugging command generator 640.

The debugging command generator 640 generates, according to the received debugging request message, a debugging command understandable for the program debugger 425, and provides the generated command to the program debugger through the remote debugging stub 423, such that the command can be used by the program debugger 425 to take corresponding control, in the group IDE therein, onto the program to be debugged.

Moreover, when the program debugger 425 finishes the debugging command, a debugging response message corresponding to that command is sent to the remote debugging commander 421 by the remote debugging stub 423. The debugging response message is received by the debugging output delivering means 630 in the remote debugging commander 421. After receiving the debugging response message from the master computer, the debugging output delivering means 630 delivers it to the debugging response message packetizing means 620. After receiving the delivered debugging response message, the debugging response message packetizing means 620 packetizes and encodes the message according to the group debugging protocol so as to return it to the slave computer sending the corresponding debugging request message or other slave computers participating the same debugging session.

FIG. 7 is a schematic diagram illustrating configuration of the remote debugging stub 423. Referring to FIG. 7, the remote debugging stub 423 comprises a debugging command executor 710 and a debugging output monitor 720.

The debugging command executor 710 checks whether there is a debugging command having been sent from a slave computer. As shown by FIG. 5, in fact, the debugging command is generated via the debugging command generator 640 of the remote debugging commander 421 according to debugging requests sent by the computers participating the group joint debugging. When the debugging commander 710 has found that the debugging command generator 640 has generated a corresponding debugging command according to the debugging request sent by the computers participating the group joint debugging, the program to be debugged is debugged by calling the corresponding debugging functions of the debugging subsystem in the existing IDE or the console based debugger (i.e. the program debugger 425 as shown in FIG. 4A).

When the debugging subsystem of the group IDE or the console based debugger finishes the corresponding debugging function as requested, the debugging output monitor 720 collects debugging response message during the runtime of the debugging subsystem of the group IDE or the console based debugger, such as current variable value, the number for the line of the code being executed currently, and output of the called program, and combines it as debugging response message to be returned to the other computers participating the group joint debugging.

The operation flow of the remote debugging commander 421 and the remote debugging stub 423 is described in detail as follow.

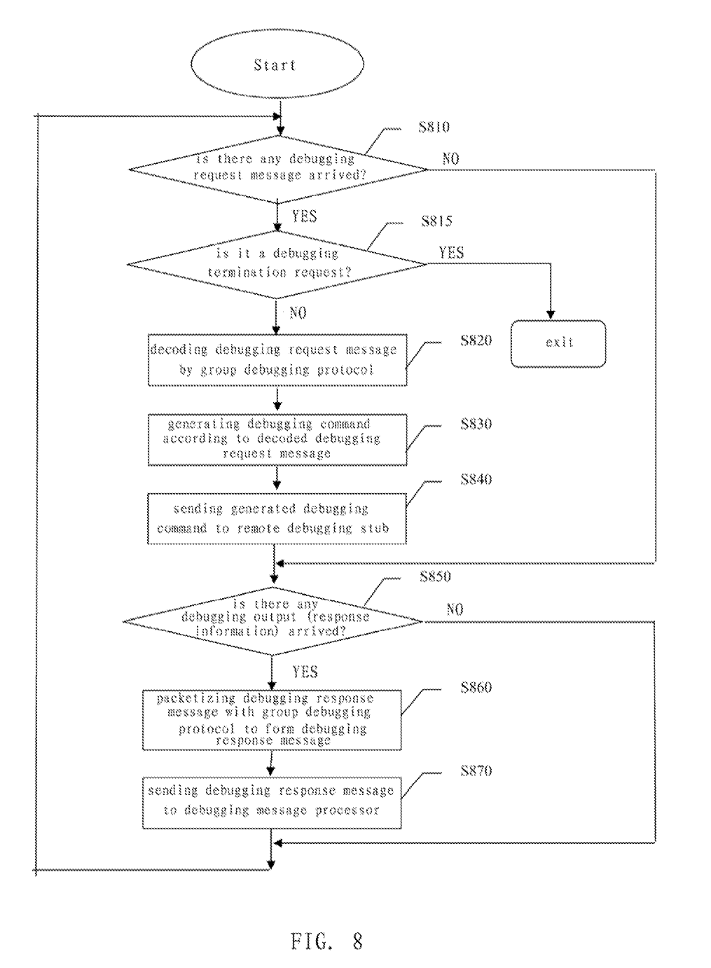

FIG. 8 is a flow chart of the working process of the remote debugging commander 421. Referring to FIG. 8, in step S810, the remote debugging commander 421 determines whether there is an incoming debugging request message sent by the computers participating the group joint debugging via the debugging message processor 413. If no debugging request message is found, then the remote debugging commander 421 turns the process to step S850, the processing of which will be further described later.

If a debugging request message is found in step S810, then in step S815 it is determined whether the debugging request message is a debugging termination request message, and if so, then the process is terminated. If the debugging request message is not a debugging termination request message, then the process proceeds to step S820 in which the remote debugging commander 421 decodes the received debugging request message by the group joint debugging protocol.

Next, in step S830, a debugging command is generated according to the decoded debugging request message. Then in step S840, the debugging command generated in step S830 is sent to the remote debugging stub 423. Then, the process proceeds to step S850. In step S850, the remote debugging commander determines whether there is a debugging response message sent by the debugging subsystem of the IDE or the console based debugger. If in step S850 no debugging response message is found by the remote debugging commander 421, then the debugging session is terminated, and the process enters another debugging session, i.e. returns to step S810.

If debugging response message is found in step S850, then in step S860 the debugging response message is packetized and encoded according to the group debugging protocol. Next, in step S870 the packetized and encoded debugging response message is sent to the relevant computers participating the group joint debugging via the debugging message processor 413. Then, the session is terminated, and the process returns to step S810 for another session.

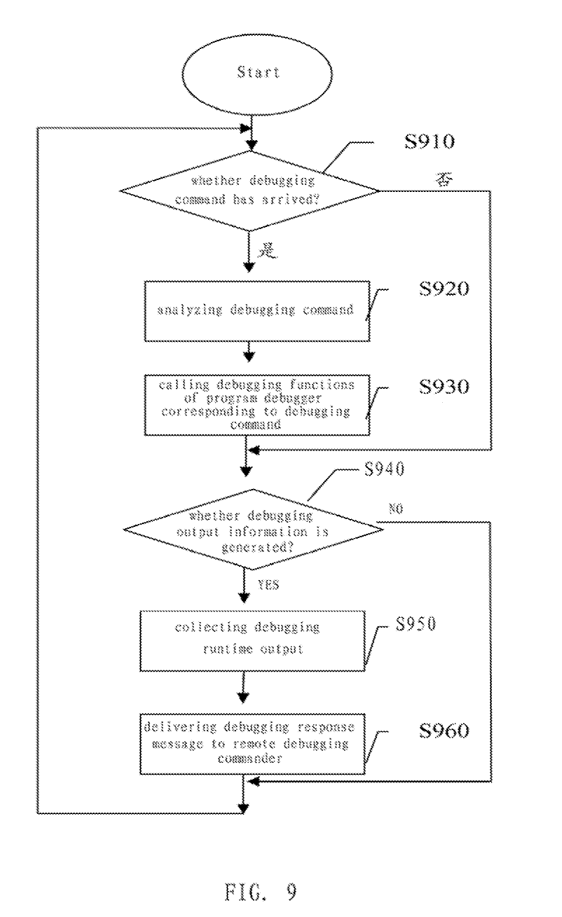

FIG. 9 is a flow chart of working process of the remote debugging stub 423. Referring to FIG. 9, in step S910, the remote debugging stub 423 determines whether there is an incoming debugging command sent by the computers participating the group joint debugging through the remote debugging commander 421. If not so, then the remote debugging stub 423 carries out step S940 which will be described in detail later.

If in step S910 a debugging command is found, then in step S920, the remote debugging stub 423 analyzes the debugging command. Next, in step S930, the functions in the debugging subsystem of the existing IDE or the console based debugger, which correspond to the debugging command, is called to debug the program to be debugged.

Next, in step S940 the remote debugging stub 423 determines whether debugging output, i.e. debugging response message, is generated by the debugging subsystem of the group IDE or the console based debugger. If in step S940 no debugging response message is found, then the process returns to step S910 to prepare for next debugging session.

If in step S940 it is determined that debugging response message is generated by the debugging subsystem of the group IDE or like, then in step S950 debugging response message during the runtime of the debugging subsystem of the group IDE or the console based debugger, such as current variable value, the number for the line of the code being executed currently, and output of the called program, is collected, and combined as debugging response message to be returned to the computers participating the group joint debugging.

Next, in step S960, the debugging response message being combined in step S950 is delivered to and processed by the remote debugging commander 421, such as being packetized and encoded, such that a debugging response message is constructed and returned back to the computer which sends the corresponding debugging request message and other computers participating the group joint debugging. Then, the debugging session is terminated, and the process returns to step S910 for a next session.

The remote debugging message processor can be implemented as an additional component of a messaging client tool or as a plug-in, an extension or an additional component of an existing IDE, which can be used to filter out remote debugging request information from general messages. The debugging request message, the debugging response message and the general message are all delivered by an existing messaging server with an existing messaging protocol.

The configuration of the master computer 310 is describe in above in connection with FIG. 3-9. The messaging processing system 323, 333, 343, 353 and 363 and the group IDE 325 and 365 on the slave computers 320-360 have configurations and functions same with those of the messaging processing system 313 and the group IDE 315 in the master computer 310. Their descriptions, therefore, are omitted.

Note that the group joint debugging system as shown in FIG. 3 is an exemplary embodiment of the present invention, it does not imply any constraints to the present invention. For example, the person having ordinary skill of the art can increase the number of the master computers and/or the slave computers, and determine whether the group IDE should be setup onto a slave computer according to the specific designing and/or application requirement.

Further, when information is delivering between a master computer and a slave computer, various general messaging systems such as electronic mail system, Java message service, session initiation protocol, instant messaging system and peer-to-peer network transmission protocol are used to deliver information or data. Information can also be delivered between a master computer and a slave computer through other network communication protocols such as IP or like.

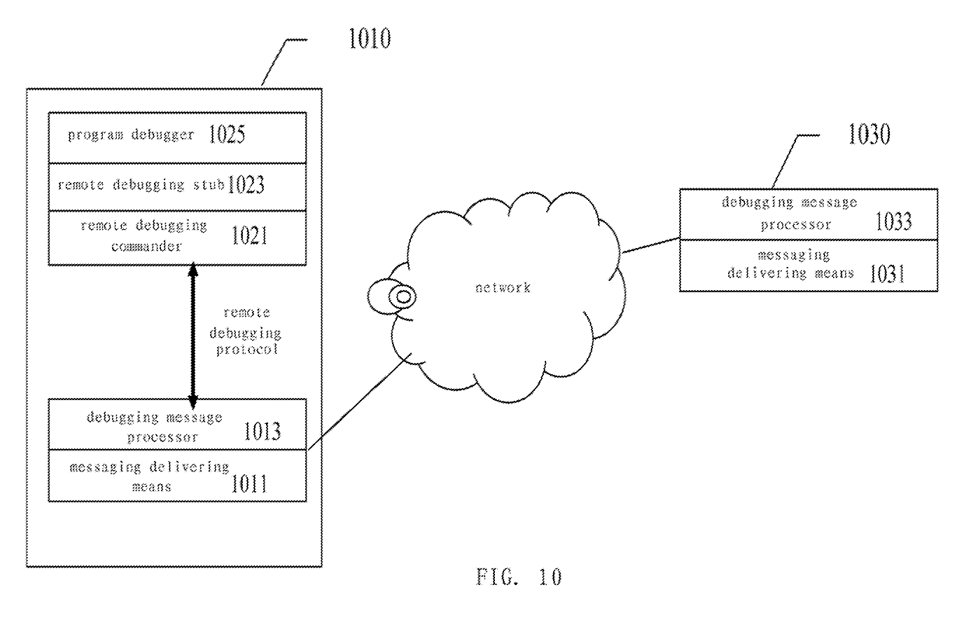

Another embodiment of the present invention will be described in detail hereafter. In the embodiment, two members from a program development team carry out joint debugging by using messaging system. FIG. 10 is an architecture diagram showing a group joint debugging system according to the present in such as a circumstance. In FIG. 10, a group joint debugging system according to the present invention comprises a master computer 1010 which belongs to one of the members. During runtime, what is running on the master computer 1010 comprises a messaging delivering means 1011, a debugging message processor 1013, a remote debugging commander 1021, a remote debugging stub 1023 and a program debugger 1025, wherein the debugging message processor 1013 communicates with the remote debugging commander 1021 with a remote debugging protocol, and the program debugger 1025 starts, in a debugging mode, a program to be debugged. These elements have the same names with those correspondences of the master computer of the group joint debugging system shown by FIG. 4A, therefore, provide same functions. Their description, hence, is omitted.

Moreover, the slave computer 1030 and the master computer 1010 perform message or data transmission by a messaging protocol, and a debugging message processor 1033 and a messaging delivering means 1031 are running at the slave computer 1030, which also provide same function with those having the same names and running at the master computer shown in FIG. 4A. Their descriptions, therefore, is omitted.

During runtime, the remote debugging stub 1023 receives a debugging command from the remote debugging commander 1021 of the master computer 1010, sends the same to the program debugger 1025, and controls executing actions of the program to be debugged according to the received debugging command. In addition, the remote debugging stub 1023 also monitors runtime output of the program to be debugged, and returns the monitoring result to the remote debugging commander 1021 of the master computer 1010.

According to the embodiment of the present invention, the remote debugging commander 1021 can be implemented as a plug-in or an extension of an IDE, it can set up a connection with the remote debugging stub 1023 on the master computer 1010 in no regard with whether the remote debugging stub 1023 is running an IDE or not. The program debugger 1025 runs in a passive mode and its behaviors are controlled by the remote debugging commander 1021.

The remote debugging commander 1021 running on the master computer 1010 receives and interprets a remote debugging request message coming from the debugging message processor 1013, and triggers a corresponding debugging command to be sent to the program debugger 1025 in order to control execution flow of the program to be debugged.

Next, the remote debugging commander 1021 receives a command response or runtime output of the program debugger, and returns the same to the corresponding debugging message processor 1013.

The debugging message processor 1013 and the messaging delivering means 1011 construct a messaging processing system. The debugging message processor 1013 sets up a connection with the remote debugging commander 1021, and interacts with it via a remote debugging protocol in order to control the program which is running on the real program debugger 1025.

The debugging message processor 1013 also detects a debugging request message from a general message delivered from the messaging delivering means 1011. Depending on an extensible program of a messaging system being used, there are several different approaches being capable to detect a debugging request message from a general message deliver from the message means 1011:

For messaging protocols which are designed with an extension mechanism, e.g. SIP and IM, just use such a mechanism to detect a debugging request message;

Extend messaging protocols to define separated debugging messages, which is very similar with the cases of supporting multimedia attachments in an email protocol which is only designed for textural information.

Use special escape characters sequence which can be processed in client side to detect a debugging message from an original text message. For example, a string “[[Debug: Run]]” can be used to present “run” command in a debugging system.

The debugging message processor 1013 also delivers a detected debugging request message to the remote debugging commander 1021, and obtains a response or runtime output corresponding to the debugging request message from the same. For example, such a response can comprise: an execution result of a debugging command contained in a debugging request message, variable values of current memory, code segment, runtime stack of a program, output of a programmer and so forth.

The messaging delivering means 1011 obtains messages from the slave computer 1030 of other group members, forwards the same to the debugging messaging processor 1013, or receives a debugging response message from the debugging message processor 1013 and sends the same to the slave computer 1030.

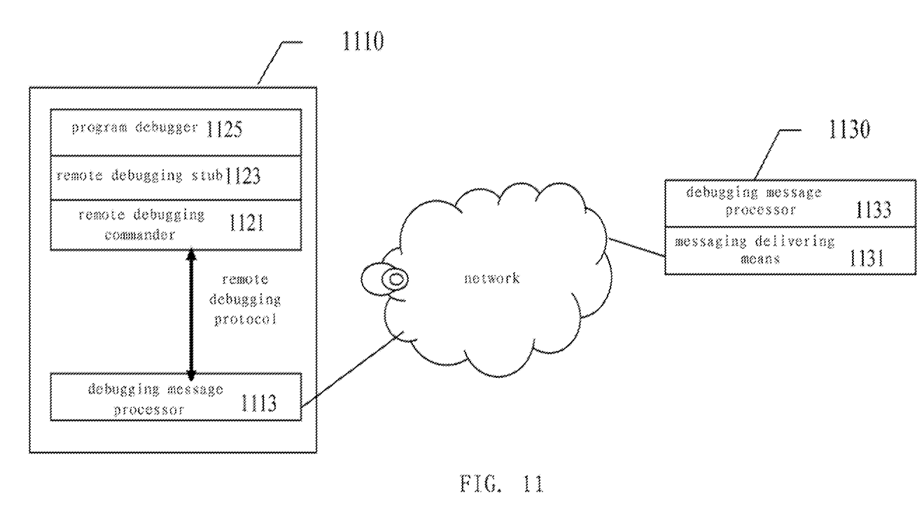

FIG. 11 illustrates a group joint debugging system according to another embodiment of the present invention. In the embodiment shown in FIG. 11, there are also two members from the development team, who are using a general purpose massaging system to perform the group joint debugging. A group joint debugging system according to the embodiment comprises a master computer 1110 and a slave computer 1130, which are operated by the two members, respectively. During runtime, the master computer 1110 has a debugging message processor 1113, a remote debugging commander 1121, a remote debugging stub 1123 and a program debugger 1125 running thereon, wherein the debugging message processor 1113 communicates with the remote debugging commander 1121 with a remote debugging protocol, and the program debugger 1125 starts, in a debugging mode, a program to be debugged. The slave computer 1130 and the master computer 1110 perform message or data transmission by a message protocol. The slave computer 1130 has a debugging message processor 1133 and a messaging processor 1131. The above elements in the group joint debugging system according to the embodiment provide same function with those having the same names and running at the master computer shown in FIG. 4A. Their descriptions, therefore, is omitted.

This embodiment, however, is different from that described with reference to FIG. 3-10, that the messaging delivering means is omitted in the master computer 1110 of this embodiment. In such a circumstance, the debugging message processor 1113 in the group joint debugging system uses a client protocol stack of a general messaging system directly to communicate with the messaging delivering means 1131, obtain messages from the messaging delivering means 1131, or send a response message to the messaging delivering means 1131 directly.

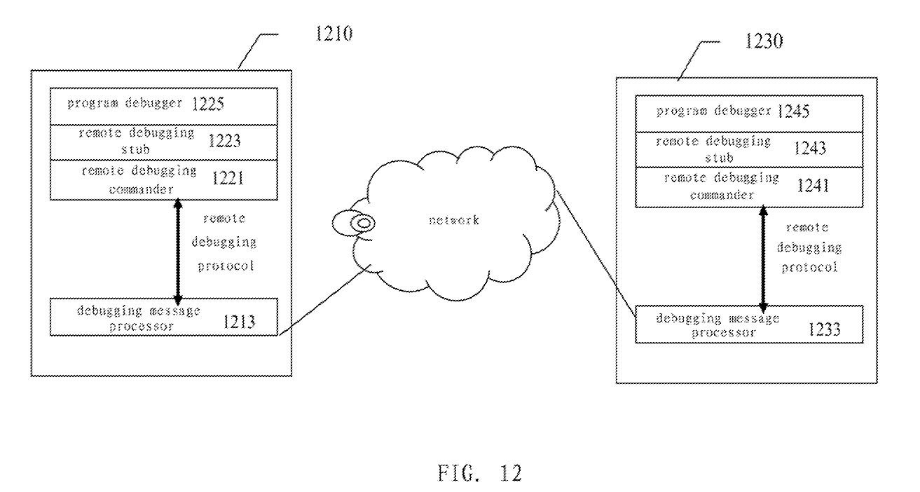

FIG. 12 illustrates a group joint debugging system according to a still another embodiment of the present invention. In the embodiment shown in FIG. 12, there are also two members from the development team, who are using a general purpose massaging system to perform the group joint debugging. A group joint debugging system according to the embodiment comprises a master computer 1210 and a slave computer 1230, which are operated by the two members. During runtime, the master computer 1210 has a debugging message processor 1213, a remote debugging commander 1221, a remote debugging stub 1223 and a program debugger 1225 running thereon, wherein the debugging message processor 1213 communicates with the remote debugging commander 1221 by a remote debugging protocol, and the program debugger 1225 starts, in a debugging mode, a program to be debugged. The slave computer 1230 also has a debugging message processor 1233, a remote debugging commander 1241, a remote debugging stub 1243 and a program debugger 1245, wherein the debugging message processor 1233 communicates with the remote debugging commander 1241 by a remote debugging protocol, and the program debugger, in a debugging mode, starts a program to be debugged. The slave computer 1230 and the master computer 1210 perform message or data transmission by a messaging protocol. The above elements in the group joint debugging system according to the embodiment provide same function with those having the same names and running at the master computer shown in FIG. 4A. Their descriptions, therefore, is omitted.

However, in this embodiment, the messaging delivering means in the master computer 1210 and the slave computer 1230 are omitted. In such a circumstance, the debugging message processors 1213 and 1233 in this group joint debugging system perform communication by using a client protocol stack of a general messaging system in order to transmit messages and corresponding response messages between the master computer 1210 and the salve computer 1230.

Moreover, it should be noted that after receiving a debugging response message, the slave computer on which an IDE (e.g. the remote debugging commander, the remote debugging stub 1243 and the program debugger 1245) is running makes processing progress synchronized in the slave computer 1230 with those in the master computer 1210.

In particular, the program debugger 1245 can also not start the program to be debugged, and in such a case, the program debugger 1245 only works as an interface interacting with a user to collect debugging actions of the user and transform them to debugging request messages to be sent to the master computer 1210; or receive a debugging response message from the master computer 12210, then display in the program debugger 1245 a corresponding debugging result from the response message.

A specific embodiment will be given in below. In this embodiment, it is assumed that two programmers, Bob and Gary, live in different cities, but they are working on a same project. In a morning, Gary modifies his code related to the project and summit the modified code to a CVS server. In the afternoon of the same day, Bob updates his code related to the project from the CVS server, but after the code being compiled, the result program can not run correctly. In such a case, Bob checks CVS log, and he finds that Gary has modified the code in that morning. Then, Bob calls Gary via a IP phone and tell Gary that the modified code can not run correctly. However, unfortunately, Gary is staying at home when he gets Bob's call, therefore Gary does not have an IDE and the code handy. But Gary can use a soft IP phone at his home which can be sufficient to help Gary and Bob to carry out debugging job for the project together. In order to carry the debugging job, Bob starts, in his group IDE, the program to be debugged and requests to invite Gary to participate a remote debugging session by SIP. Gary accepts the invitation and participates the remote debugging session. During the remote debugging session, Gary can obtain a program code segment by sending a “list” command through SIP, or set up a break point in the program by sending a “break point” command through his soft IP phone. Bob reproduces program bugs he experiences by repeating all his operating steps, but the program will be stopped at the breaking points set by Gary. After the program stops, Gary can run the program on a step basis by sending a “next” debugging command from his soft IP phone UI, or check variable values of the program by sending a “print” command. With work of Bob and Gary during the above remote debugging session, the program bugs will be found finally.

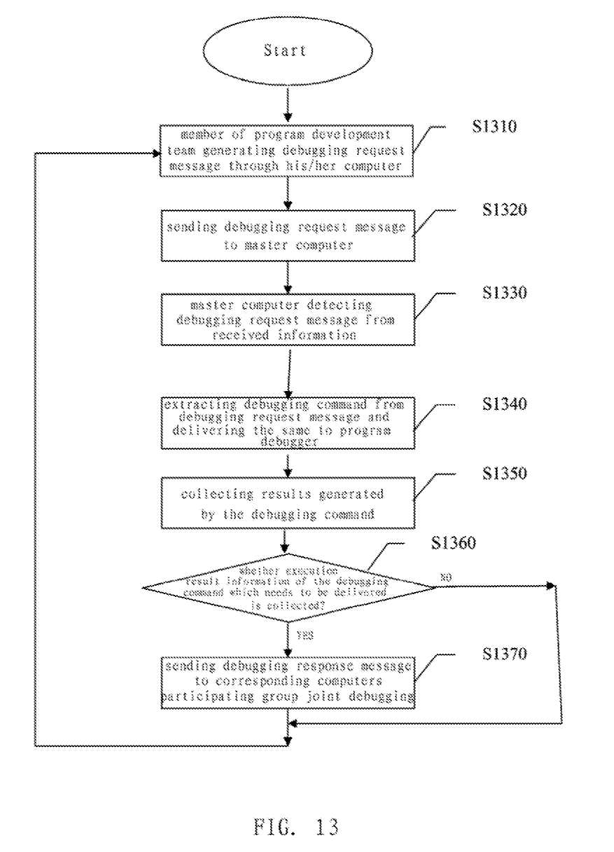

FIG. 13 illustrates a operation flow of a group joint debugging system according to an embodiment of the present invention. In the flow chart of the group joint debugging method shown in FIG. 13, any member from a program development team can start a debugging session. In step S1310 of FIG. 13, a member of the team generates a debugging command by using his or her computer, and packetizes and encodes the generated debugging commands to form debugging request messages.

Then, in step S1320, after being encapsulated by a corresponding protocol of a general messaging system, the debugging request message is then sent to a computer called as a master computer through network, wherein the master computer can identify the debugging request message from the received messages, and send the same to the group IDE on which a program debugger and the program to be debugged are running.

Next, in step S1330, the master computer detects the debugging request message sequentially from the received messages till the debugging request message is detected. If in step S1330 a debugging request message is detected, the master computer extracts a debugging command from the debugging request message in step S1340, and delivers the same to the program debugger on which the debugging command is performed on the program to be debugged. After the debugging command is performed on the program to be debugged, results of performing the debugging command such as execution results of the debugging command contained in the debugging request message, variable values of current memory, code segment, program runtime exception stack, program output and like, are collected in step S1350. Then it is judged whether any execution result information of the debugging command to be delivered is collected in step S1360. If no execution result information of the debugging command is collected, then this session is terminated.

It is judged in step S1360 whether an execution result information of the debugging command which needs to be delivered through network is collected, and if so, then in step S1370 the collected execution result information of the debugging command is send to corresponding slave computers participating the group joint debugging, as a response information to the debugging command.

With the above group joint debugging system according to the present invention, respective members of a software development team can carry out joint debugging session easier and more prompt than do the same with a conventional method, In particular, the present invention provides following benefits:

A group debugging session can be started easily and quickly since only if a tool such as IM is used, a debugging request message can be sent in order to participate the joint debugging operation.

A lightweight system can be achieved since only if one member from a development team runs, in a group joint debugging system, a program to be debugged, then the remaining members need not to configure the system to start the program, in contrast with that in a current symmetric debugging system, every member has to starts, in his or her own IDE, an instance of the program to be debugged.

Moreover, it is platform independent since messaging systems such as IM and Email have been supported by a variety of computer platforms.

In the above description, preferable embodiments according to the present invention explain the group joint debugging system and its operating method. It should be understood by the person having ordinary skill in the art, that both the system and the method can be implemented as computer readable code recorded on a computer readable recording medium. The computer readable recording medium can be any data storage means recorded with data accessible by a computer system. Examples of the computer readable recording medium comprise a read only memory (ROM), a random access memory (RAM), a CD-ROM, a magnetic tape, a floppy disk, an optical data storage means and carrier such as data transmission through Internet. The computer readable recording media can be distributed over networked computer systems so as to store and execute the computer readable code in a distributed fashion.

Although the present invention is described in above by referring to the exemplary embodiments, it should be understood by the person having ordinary skill in the art that various changes and modifications can be made to the present invention without departing from the spirit and scope thereof which is defined by the attached claims. The preferable embodiments are explanatory and not to be taken in a limiting sense. The scope of the present invention is not limited by the previous detailed description but should be defined by the attached claims, and it should be understood that all distinguishing technical features within the scope of the present invention are encompassed by the present invention.

That which is claimed is:

1. A messaging system based group joint debugging system, comprising:
at least one master computer for loading a program debugger and a program to be debugged via a operating system, obtaining a debugging request message containing a debugging command via the messaging system, extracting the debugging command and calling a corresponding debugging function of the program debugger according to the debugging command, and sending execution result of the called debugging function, as a debugging response message, to remaining computers participating in a group joint debugging, such that the group joint debugging is carried out to the program to be debugged; and
at least one slave computer in mutual communication with the master computer through network, for generating the debugging command according to a debugging action of a user, forming a debugging request message containing the debugging command, and sending the debugging request message to the master computer through the messaging system, and for receiving the debugging response message from the master computer, and displaying the result of the corresponding debugging action to the user according to the debugging command and the corresponding debugging result information in the debugging response message.

2. The group joint debugging system of claim 1, wherein the slave computer is configured with a program debugger for loading the program to be debugged and generating the debugging command according to a debugging action of a user and/or the debugging response message, thereby generating the debugging request message and synchronizing with processing progress of the master computer according to the debugging response message.

3. The group joint debugging system of claim 1, wherein the messaging system is any of electronic mail system, instant messaging system, Java message service, session initiation protocol or peer-to-peer network transmission protocol.

4. The group joint debugging system of claim 1, wherein the master computer is configured with:
a first messaging processing system for, through the messaging system, receiving the debugging request message and outputting the same after being processed, and delivering debugging response message corresponding to the debugging request message to the computers participating in the group joint debugging; and
a group IDE for generating the debugging command according to the debugging requesting message output from the first messaging processing system, calling a debugging function in the program debugger corresponding to the debugging command to debug the program to be debugged, collecting debugging result information, and forming the debugging response message as a response to the debugging request message.

5. The group joint debugging system of claim 4, wherein the first messaging processing system comprises a debugging message processor for detecting the debugging request message in the incoming messages, delivering the detected debugging request message to the group IDE through a group debugging protocol, and returning response messages output by the group IDE to the computers participating in the group joint debugging after the group IDE finishes the processing on the debugging request message.

6. The group joint debugging system of claim 5, wherein the first messaging processing system further comprises a messaging delivering means for delivering the debugging request message received from the messaging system to the debugging message processor, and sending the response information delivered from the debugging message processor and regarding the debugging request message to the computers participating in the group joint debugging through the messaging system.

7. The group joint debugging system of claim 6, wherein the debugging message processor comprises a debugging request message detector for detecting whether the incoming message is the debugging request message for debugging purpose when receiving the message.

8. The group joint debugging system of claim 7, wherein the group IDE is implemented as a plug-in, an extension or an additional component, and comprises:
a program debugger for carrying out the debugging action according to the debugging commands;
a remote debugging commander for buffering the incoming debugging request messages in a queue fashion, generating the debugging commands being understandable by the program debugger, and packetizing and encoding the response information of the program debugger and sending the same to the first messaging processing system through the group debugging protocol; and
a remote debugging stub for receiving the debugging command from the remote debugging commander, calling debugging functions of the program debugger corresponding to the debugging command, and collecting and combining debugging response message after the debugging functions is executed so as to deliver the same to the remote debugging commander.

9. The group joint debugging system of claim 8, wherein the remote debugging commander comprises:
a debugging request message delivering means for receiving the debugging request messages and buffering the received debugging request messages in a queue fashion;
a debugging command generator for generating the debugging commands being understandable by the program debugger according to the buffered debugging request messages, and providing the commands to the program debugger via the remote debugging stub such that the program debugger uses the commands to make corresponding control onto the program to be debugged;
a debugging output delivering means for delivering the debugging response message to the debugging response message packetizing means after receiving it; and
a debugging response message packetizing means for packetizing and encoding the delivered debugging response message after receiving it so as to send the same to the first messaging processing system through the group debugging protocol,
wherein the debugging request messages are packetized and encoded with the group debugging protocol format, and analyzed and translated to the debugging commands by the debugging command generator.

10. The group joint debugging system of claim 8, wherein the remote debugging stub comprises:
a debugging command executor for calling corresponding debugging functions in the program debugger to debug the program to be debugged when the debugging command is arrived; and
a debugging output monitor for collecting runtime output information and combining it as the debugging response message to be delivered to the remote debugging commander when the program debugger finishes the called corresponding debugging functions.

11. The group joint debugging system of claim 1, wherein the slave computer is configured with a second messaging processing system for receiving the debugging response message from the master computer through the messaging system and processing the same, or sending the debugging request message containing debugging action of the user to the master computer.

12. A messaging system based group joint debugging method, comprising steps of:
(a) generating a debugging command according to a debugging action of a user, and packetizing and encoding the generated debugging command to form a debugging request message;
(b) sending, by a messaging system, the debugging request message to a master computer, on which a program debugger and a program to be debugged are running;
(c) receiving, by the master computer, message through the messaging system, and detecting the debugging request message in the received message;
(d) extracting the debugging command in the debugging request message;
(e) calling debugging functions from the program debugger according to the debugging command in order to control the program to be debugged;
(f) collecting debugging results generated by execution of the debugging command after the debugging command has been executed on the program to be debugged;
(g) constructing a debugging response message;
(h) sending the debugging response message to computers participating in the group joint debugging through the messaging system; and
(i) receiving the debugging response message from the master computer and displaying the result of the corresponding debugging action to the user according to the debugging command and the corresponding debugging result information contained in the debugging response message.

13. The group joint debugging method of claim 12, wherein at least one of computers participating the group joint debugging is loaded with the program to be debugged, and the debugging command is generated according to the debugging response message and the user's debugging action thereby synchronization with processing progress of the master computer is kept.

14. The group joint debugging method of claim 12, wherein the messaging system is any of electronic mail system, instant messaging system, Java message service, session initiation protocol or peer-to-peer network transmission protocol.

15. The group joint debugging method of claim 12, wherein step (c) comprises sub steps of:
receiving message through the messaging system;
judging whether received message is the debugging request message; and
sending the debugging request message to the group IDE through the group debugging protocol when the debugging request message is detected.

16. The group joint debugging method of claim 12, wherein step (d) comprises sub steps of:
receiving the debugging request message and buffering the received debugging request message in a queue fashion; and
generating the debugging command understandable by the program debugger according to the buffered debugging request message,
wherein the debugging request message is packetized and encoded in the group debugging protocol format, and the debugging command is generated by analyzing and translating the debugging request message.

17. The group joint debugging method of claim 12, wherein step (f) comprises sub steps of:
collecting the debugging result generated by the debugging command as the debugging response message;
determining whether there is the debugging response message to be delivered; and
when it is determined that there is the debugging response message to be delivered, executing step (g) to packetize and encode the debugging response message according to the group debugging protocol, and generating a response message.
